(19) United States
(12) Patent Application Publication
(10) Pub. No.: US 2025/0335462 A1
(43) Pub. Date: Oct. 30, 2025

(54) STORAGE FAILURE HANDLING AND REBALANCE IN DATABASE AWARE DISTRIBUTED DATA STORE

(71) Applicant: Oracle International Corporation, Redwood Shores, CA (US)

(72) Inventors: Siddharth Choudhary, Belmont, CA (US); Vijay Sridharan, Santa Clara, CA (US); Dongqiao Ma, San Jose, CA (US); Jingtao Xu, Fremont, CA (US); Wenwen Han, Redwood City, CA (US); Nilesh Choudhury, Redwood City, CA (US); Jia Shi, Campbell, CA (US)

(21) Appl. No.: 18/645,495

(22) Filed: Apr. 25, 2024

(51) Int. Cl. G06F 16/27

(52) U.S. Cl. CPC G06F 16/27

(57) ABSTRACT

For database high availability and for accelerated recovery of a failed replica of a database, a storage computer is dynamically allocated and temporarily persists database content modifications until the database replica is ready to receive the modifications. The storage computer is not allocated storage that stores the database. The storage computer persists a recent portion of the database and later receives a request to synchronize the recovering replica. During recovery, the storage computer responsively sends the portion of the database to the recovering replica. For acceleration, recovery herein does not entail content interpretation such as replay of a redo log. For horizontally scaled acceleration involving two distinct storage computers per recovering replica, multiple replicas are concurrently recovered by respective storage computers that each receives recovered database content only from a respective distinct other storage computer.

### FIELD OF THE DISCLOSURE

This disclosure relates to database high availability. For accelerated recovery of a failed database replica, a storage computer persists database content modifications until the database replica is ready to receive the modifications.

### BACKGROUND

A database management system (DBMS) may involve a stack of infrastructure layers such as processing, persistence, and networking that may be more or less unreliable. Reliability, availability, and serviceability (RAS) may include high availability based on redundancy of replicas so that there is no single point of failure that can incapacitate the DBMS or its infrastructure stack. An outage of a replica may be planned or unplanned, and the outage may be due to a component being temporarily or permanently unavailable. Herein, a component is considered permanently unavailable if hardware is damaged or a deployment is decommissioned, in which case recovery may entail rebuilding or relocation of the replica.

Most outages instead are transient and automatic recovery may, for example, be performed by the DBMS or its infrastructure stack. The duration of a transient outage is measured in minutes or a few hours. Examples of a transient outage include planned maintenance, a datacenter power outage, a computer or software crash and restart and, as follows, an unhealthy hard disk drive.

In an Oracle Exadata® cloud database system as a demonstrative example, disk confinement is a process for automatically identifying and managing underperforming disks. The system continuously monitors the performance of all disks. If a performance deficiency of a disk is observed, the disk is considered underperforming, and the disk may become confined (i.e. deliberately taken out of service). The confined disk undergoes diagnostic tests to determine the cause of the slow performance. If the disk passes the tests, indicating the slowdown was temporary, the disk is brought back online and returned to service.

Example reasons why disk slowness might be temporary include the following. Firmware of a disk controller or software of a device driver may have a defect that is gradual or infrequent. Even a completely healthy disk may appear unhealthy while overwhelmed by a sudden surge in usage. For example, a demand spike might unfortunately be concurrent to a scheduled background process of the disk drive. Confinement does not entail physical removal of the disk.

No matter which component or cause of an outage of a database replica, surviving replica(s) remain in service and in synchronization with each other. In other words, available replicas always are more or less perfect mirrors (i.e. exact copies) of each other. Surviving database replicas may accumulate changes such as content modifications, and a replica that is out of service does not receive those changes until recovery while preparing to return to service. State of the art synchronization may entail transmission of sequential data such as change vectors in a sequence of redo entries in a log or, when a stream is used instead of a log, entries that are change events or change rows that are higher level and more portable than change vectors. In any case, state of the art synchronization is sequentially applied to the receiving replica, either by interpreted replay of redo change vectors or by interpreted replay of change events and change rows. Interpreted replay may also be referred to as content interpretation.

Replay means that the final (i.e. synchronized) state of a database object may be the sequential result of applying multiple changes in a particular ordering provided in the stream or log that contains synchronization data. For example, a synchronization log or stream may contain: a) a first entry that assigns an initial value to a field in a row of a database table and b) a second entry that assigns a revised value to the field in the row. Correct synchronization occurs only if the second entry is applied last, and applying the first entry is entirely optional. However, state of the art replay cannot detect that applying the first entry was optional until after applying the first entry. Thus, state of the art synchronization is inherently inefficient due to its sequential nature. In other words, the state of the art wastes time and electricity that includes processor cycles or disk latency by processing logically extraneous changes when applying synchronization data. This waste may decrease the lifespan of a persistence medium such as disk or flash. Although implementations may impose some maximum, there is no logical inherent limit to how many changes should be replayed for a same database block. In other words, waste during state of the art recovery may be more or less unbounded and independent of how many database blocks need recovery.

Outage of a state of the art database replica may cause a redo gap such that recovery of the replica requires a surviving replica to send a redo log to the recovering replica, and replication lag increases the size of the gap. Redo gap filling increases network and processing load on the surviving replica, which increases OLTP latency of the surviving replica during recovery.

### BRIEF DESCRIPTION OF THE DRAWINGS

In the drawings:

FIG. 1 is a block diagram that depicts an example distributed system that provides high availability with three replicas of a database;

FIG. 2 is a flow diagram that depicts an example process that a delta storage computer may perform for recovery of a database replica;

FIG. 3 is a flow diagram that depicts an example system process in which multiple storage computers concurrently recover multiple database replicas;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

This disclosure relates to database high availability. For accelerated recovery of a failed database replica, a storage computer persists database content modifications until the database replica is ready to receive the modifications. This approach entails innovative storage failure handling and efficient data movement for resynchronization and rebalancing in a distributed manner for a database-aware distributed data store. When a failure occurs in a database storage cluster, it can be classified as a temporary failure or a terminal failure. In case of a temporary failure, a resynchronization is needed. Herein, a delta storage computer is a self-aware, sparse, and self-contained temporary but persistent mirror for a database. This novel storage computer works as a proxy for a real mirror for handling allocations, updates, and deletions to externally appear like any true mirror. Replication content sparseness herein is a way to track updates for the real mirror in a space efficient manner.

Herein, the unit of database persistence is a database block that contains an array of bytes that represent database content, and various database objects may be composed of various amounts of database blocks. This approach is based on a novel storage computer, referred to herein as a delta storage computer, that is innovative for what kind of data it persists and for what kind of data it does not receive and does not store. Unlike a database storage computer that may store a whole database or a fully operational partition of a distributed database, a delta storage computer does not store a database. A delta storage computer is allocated as a proxy of a particular database storage computer that is experiencing an outage. The delta storage computer receives and stores only database blocks that were recently modified. The delta storage computer stores only a latest version of database blocks, which consists of revisions that the unavailable database storage computer has not yet received. Materialized dirty (i.e. modified) database blocks are the only database content that the delta storage computer receives and stores. If a database object such as a database table consists of many unmodified database blocks and a few modified database blocks, the delta storage computer does not receive and store the whole database object and instead receives and stores only the modified database blocks. In other words, the delta storage computer does not store unmodified database blocks nor stale modified database blocks that are not the latest version. In that way, persistence by the delta storage computer is sparse, which is extremely efficient in time and space. The delta storage computer also does not receive or store files, logs, redo entries, change vectors, change events, nor change rows. This new way of retaining unapplied modifications improves database recovery performance in the following important ways.

All database operations such as writes, trims, snapshot deletes, file level deletes, volume level deletes, and sparseness based file/snapshot reinitialization are supported in ways that facilitate accelerations herein. This approach uses minimal space for tracking resynchronization information while providing an independent failure recovery mechanism that neither requires nor burdens surviving mirrors during resynchronization, and this unprecedented decoupling of surviving replicas from recovering replicas increases the throughput and fault tolerance of the system during recovery. Dense packing and compact transmission of recovery data and metadata provide highly efficient resynchronization, which is an acceleration that may also be used for rebalancing and rebuilding.

Herein, recovery of each database replica is individually accelerated by novel avoidance of content interpretation such as redo replay as discussed in the above Background. Additional recovery accelerations achieved include: a) a surviving database storage computer avoids gap filling that is discussed in the Background and b) horizontal scaling occurs when multiple delta storage computers concurrently send recovered data to recover multiple unavailable replicas.

Network transmission for recovery is highly optimized. If a monitoring computer does not detect network saturation during transmission of recovery data by a delta storage computer, the monitoring computer may notify the delta storage computer to increase the data transmission rate. In that way, transmission of recovered data may be opportunistically accelerated without increasing latencies of a database server and surviving database storage computers. Two advantages of this approach during recovery are that transmission of recovered data is accelerated and that latency of ongoing online transaction processing (OLTP) is minimized. For acceleration by decreased count of network round-trips, a flush of a network buffer is atomic such that multiple database blocks are flushed together in a same network transmission, even if the database blocks are parts of different respective database objects such as separate database tables.

1.0 Example Distributed System with Multiple Example Storage Computers

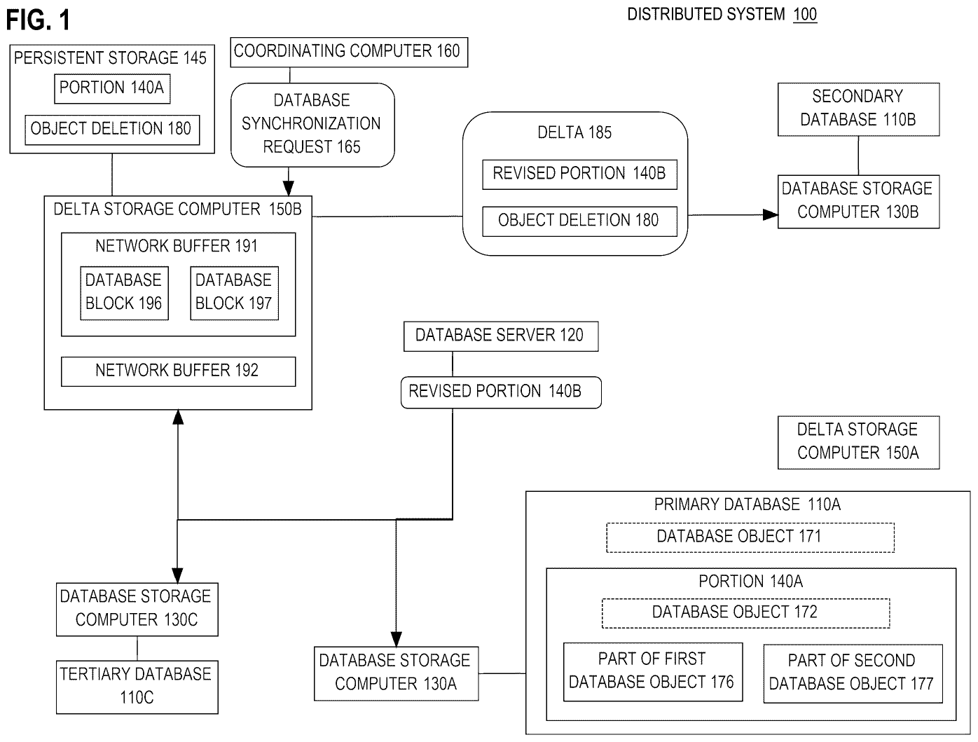

FIG. 1 is a block diagram that depicts example distributed system 100 that provides high availability for replicated database 110, shown as three replica databases 110A-C. For accelerated recovery of failed replica secondary database 110B, delta storage computer 150B persists database content modifications, including portion 140 of replicated database 110, until replica secondary database 110B is ready to receive the modifications. Each of computers 130A-C, 150A-B, and 160 may be a rack server such as a blade, a mainframe, a virtual machine, or other computing device. Although not shown, all computers in distributed system 100 are interconnected by one or more communication networks. For example, distributed system 100 may be contained in a datacenter or distributed across multiple datacenters. In an embodiment, distributed system 100 is part of a public or private cloud.

### 1.1 Database Server can Use Many Replicas of Database

For ease of discussion, replica databases 110A-C are respectively shown as having primary, secondary, and tertiary roles. However, the approach herein is not based on high availability roles and, in an embodiment, database server 120 may directly cooperate with any of database storage computers 130A-C that respectively store replica databases 110A-C. Database server 120 comprises a computer and a database management system (DBMS) that operates replicated database 110 on behalf of client(s). For example, database server 120 may receive data manipulation language (DML) and data definition language (DDL) statements from clients and may use replicated database 110 for online transaction processing (OLTP).

In the shown example, database server 120 executes a database statement or stored procedure that specifies DML or DDL that makes one or more changes to one or more database objects in replicated database 110, and database server 120 sends these changes, shown as revised portion 140B, to storage computers that will persist copies of revised portion 140B. Components 140B, 165, and 185 are shown as rounded rectangles to indicate that these components are data structures sent between two respective computers through a communication network.

Ideally, all three replica databases 110A-C are operational, and database server 120 would send revised portion 140B to all replica databases 110A-C. In that case, replica databases 110A-C would be identical before receiving revised portion 140B and would be identical after receiving and storing revised portion 140B. During full availability, all replica databases 110A-C are operational, and database server 120 may retrieve contents of replicated database 110 by sending a read request to any one of database storage computers 130A-C that are allocated respective persistent storage that respectively stores replica databases 110A-C.

Database server 120 may perform create, read, update, and delete (CRUD) operations on replicated database 110. Database server 120 sends copies of a write operation to all database storage computers 130A-C that are currently in service. In an embodiment, database server 120 sends a read request only to database storage computer 130A that is allocated persistent storage that contains replica primary database 110A. For example if replica primary database 110A were to fail, then replica secondary database 110B may dynamically switch roles from secondary to primary, in which case replica secondary database 110B would receive read operations. In that example, database writes are effectively broadcast to all available replicas, and reads are sent to only one replica.

In an embodiment, a primary replica might, for example, be designated and used as the only readable replica, and all other available replicas are effectively writable-only until the primary fails. In an embodiment, write activity such as OLTP is directed to the primary replica, and read activity such as online analytical processing (OLAP) or reporting is instead directed to a non-primary replica. In a load balanced embodiment, database server 120 may opportunistically send a read operation to a least busy replica. Thus, various embodiments may be role based (e.g. primary, secondary) or may be load balanced, and the approach herein is agnostic to these topology alternatives.

### 1.2 Replica Outage

By design, high availability can tolerate an outage of one or a few of replica databases 110A-C so long as at least one replica remains in service. In the shown scenario, replica secondary database 110B experiences an outage such as: a) a crash of the disk that stores replica secondary database 110B, b) a crash of database storage computer 130B, or c) maintenance of either of components 110B or 130B. In an embodiment, this outage may be detected and managed by coordinating computer 160, also referred to herein as a cluster manager. In an embodiment, coordinating computer 160 receives notifications of technical problems in distributed system 100 such as network outages, power outages, computer crashes, maintenance outages and, as discussed in the above Background, disk confinement.

Coordinating computer 160 may react to the outage of replica secondary database 110B by dynamically configuring delta storage computer 150B to operate as a minimal and temporary replacement of database storage computer 130B. For example, the outage of replica secondary database 110B might be due to a crash of database storage computer 130B or a power outage or network outage of a datacenter that hosts database storage computer 130B. For example, storage computers 130B and 150B might be in separate datacenters. Thus herein, a delta storage computer is a minimal and temporary replacement of database storage computer.

### 1.3 Two Kinds of Storage Computer

Herein, a storage computer is also referred to as a storage cell. Herein, a storage computer does not host: a) database server 120, b) applications, nor c) middleware such as a DBMS. In an embodiment, a database storage computer and a delta storage computer have similar capacities and capabilities and may, for example, be dynamically allocated from and returned to a general pool of storage computers that are generally configured for bulk data persistence such as files, databases, or disk blocks on a hardware drive. In an embodiment, database server 120 may offload table scans and content filtration to database storage computers but not delta storage computers.

Until recovery of replica secondary database 110B begins, delta storage computer 150B operates as write-only, even if database storage computer 130B was not write-only when the outage began. As discussed earlier herein, database server 120 effectively broadcasts revised portion 140B to all available database replicas. In an embodiment, coordinating computer 160 notifies database server 120 that delta storage computer 150B is a write-only replacement of database storage computer 130B and, as shown, database server 120 sends revised portion 140B to surviving database storage computers 130A and 130C and to delta storage computer 150B instead of database storage computer 130B. Herein, survival of a database replica means the replica remains in service despite an outage of another replica of database 110.

In an embodiment, the network address or hostname of unavailable database storage computer 130B is reassigned to delta storage computer 150B, and coordinating computer 160 does not notify database server 120 that database storage computer 130B is replaced by delta storage computer 150B. For example, database server 120 might be unaware that revised portion 140B is received by delta storage computer 150B instead of database storage computer 130B.

### 1.4 Preservation of Replication Content

Storage computers 130A, 130C, and 150B receive and retain revised portion 140B, including more or less immediately saving revised portion 140B into persistent storage. For example, delta storage computer 150B will store revised portion 140B in persistent storage 145 that may be a local drive attached to delta storage computer 150B or a remote drive. In an embodiment, persistent storage 145 is a block storage device such as a hardware drive such as a disk drive or a solid state drive (SSD).

In the shown example: portions 140A-B are modifications of replicated database 110 made while replica secondary database 110B is unavailable, b) portion 140A is initial modification(s) made before revised portion 140B, and c) portions 140A-B have different values for a same database data portion. In other words, portions 140A-B are different versions of a same data portion and, in replicated database 110, portion 140A should be replaced (i.e. overwritten) by revised portion 140B. In an embodiment, each of portions 140A-B is a database block that is a byte array whose fixed size may be a fraction or a multiple of a memory page or of a storage block such as a disk block.

In that way, persistent storage 145 stores either of portions 140A-B but will not retain both concurrently. Resynchronization (i.e. recovery) of replica secondary database 110B is accelerated beyond the state of the art by delta storage computer 150B that, during recovery, has and provides revised portion 140B without wasting recovery time to process portion 140A that no longer exists. Using delta storage computer 150B for recovery always is faster than state of the art recovery using a redo log. Using delta storage computer 150B for recovery of a database block also requires less disk space than a state of the art redo log that, for example, contains many change vectors in many redo entries for a same database block.

### 1.4 Recovery of Unavailable Replica

Recovery of replica secondary database 110B is managed by coordinating computer 160 as follows. In an embodiment, coordinating computer 160 instructs delta storage computer 150B to resynchronize replica secondary database 110B. In an embodiment, coordinating computer 160 instead instructs database storage computer 130B to request resynchronization from delta storage computer 150B. In either case, delta storage computer 150B sends delta 185 that contains revised portion 140B to database storage computer 130B that receives and stores revised portion 140B into replica secondary database 110B. Either of storage computers 130B and 150B notifies coordinating computer 160 that resynchronization is finished, and: a) components 110B and 130B return to service, and b) components 145 and 150B may be deallocated or decommissioned because they are no longer needed for techniques herein. In other words, delta storage computer 150B is only a temporary replacement for database storage computer 130B. In an embodiment, coordinating computer 160 notifies database server 120 that replica secondary database 110B is again available.

In an extended scenario in the following sequence: a) replica secondary database 110B becomes unavailable and then b) replica primary database 110A becomes unavailable before replica secondary database 110B can begin recovery, such that c) both replica databases 110A-B are concurrently unavailable. In that case, only surviving replica tertiary database 110C is available.

### 1.5 Multiple Unavailable Replicas and Accelerated Recovery

Herein, replacement means temporarily replacing a database storage computer with a delta storage computer. In addition to temporarily replacing database storage computer 130B with delta storage computer 150B as discussed above, coordinating computer 160 also temporarily replaces database storage computer 130A with delta storage computer 150A. Thus, coordinating computer 160 makes two replacements but not at exactly the same time. That is, first the secondary is replaced and then the primary is replaced, because primary and secondary did not fail at exactly the same moment in time. For example, failure of the secondary might have caused a load balancer to increase the load on the surviving primary and tertiary, and stress of that rebalancing might have contributed to the primary failing. In that case, there are multiple failed database replicas and, for example, only replica tertiary database 110C survives.

Herein, recovery of replica databases 110A-B are individually accelerated by novel avoidance of content interpretation as discussed in the above Background. Recovery of replica databases 110A-B does not entail inspection or modification of bytes within a recovered database block, and delta storage computers herein never inspect or modify bytes within a database block. In that way and unlike content interpretation, recovered database blocks herein are treated as opaque, and delta storage computers herein are not configured to process recovery data such as redo, change vectors, change events, and change rows.

Additional recovery accelerations achieved include: a) surviving database storage computer 130C avoids gap filling as discussed in the Background and b) horizontal scaling occurs when delta storage computers 150A-B concurrently send recovered data portions to recovering respective database storage computers 130A-B as discussed later herein.

### 1.6 Database Object Deletion

Herein, examples of a database object are a database block, a file, a volume, a database snapshot, and a tablespace. In an embodiment, each of components 140A-B, 171-172, and 176-177 consists of one or more database blocks. In an OLTP embodiment, the fixed size of a storage block such as a disk block may be a whole multiple of the fixed size of a database block. In other words, a storage block may contain multiple database blocks. Whole or partial database objects 171-172 and 176-177 may operate according to the following example scenarios. In any case, each of partial database objects 176-177 consists of at least one whole database block. Partial database objects 176-177 are respectively shown as part of first database object 176 and part of second database object 177 that may be parts of different database objects.

Object deletion 180 may be an indication of deletion of all database block(s) of either one of whole database objects 171-172 according to the following example deletion scenarios. Database objects 171-172 are shown with dashed outlines to indicate that they will be deleted by database server 120 as follows.

In one scenario while replica secondary database 110B is unavailable, database object 171 is unmodified until database object 171 is deleted. In other words, neither of components 145 and 150B contain any data or metadata of database object 171 when database object 171 is deleted. When database server 120 notifies delta storage computer 150B that database object 171 is deleted, delta storage computer 150B stores object deletion 180 in persistent storage 145. In that case, object deletion 180 does not contain any content of database object 171.

In an embodiment, object deletion 180 contains only identifier(s) or identifier range(s) of deleted database blocks. In an embodiment, an identifier of a database block consists of: a) an integer that identifies a file that contains an array of database blocks and b) an integer that is the relative offset of the database block in the array.

In another scenario while replica secondary database 110B is unavailable, database object 172 is modified in portion 140A. When database server 120 notifies delta storage computer 150B that database object 172 is deleted, delta storage computer 150B performs both of: a) stores object deletion 180 in persistent storage 145 and b) if delta storage computer 150B already has database block(s) of database object 172 stored in persistent storage 145, then those database blocks are deleted.

Object deletion 180 is included in delta 185 during recovery of replica secondary database 110B. When database storage computer 130B receives object deletion 180 during recovery, database storage computer 130B deletes, from replica secondary database 110B, any database blocks identified by object deletion 180. Delta 185 does not contain contents of database blocks identified by object deletion 180.

### 1.7 Network Activity of Recovery

Recovery (i.e. resynchronization) of replica secondary database 110B entails networking as follows. Delta storage computer 150B copies and densely packs recovered data from persistent storage 145 into network buffers 191-192 in volatile random access memory (RAM). The fixed size of a network buffer may be a whole multiple of the fixed size of a database block. In other words, each of network buffers 191-192 may contain one or more database blocks. For example as shown, network buffer 191 contiguously contains database blocks 196-197.

For acceleration by decreased count of network round-trips, a flush of network buffer 191 is atomic such that database blocks 196-197 are flushed together in a same network transmission. Delta 185 may contain all of network buffers 191-192, which does not mean that network buffers 191-192 are flushed together in a same network transmission. In other words, delta 185 may consist of multiple network transmissions including, for each of network buffers 191-192, one transmission containing one buffer flush.

Dense packing of database blocks 196-197 may mean that network buffer 191 may contain multiple whole or partial database objects. In the following examples, each of partial database objects 176-177 is a part of a distinct respective database object such as a database table. In one example, partial database objects 176-177 are separately stored in distinct respective network buffers 191-192 and separately flushed in separate network transmissions. In another example, database blocks 196-197 respectively represent partial database objects 176-177 and, in an embodiment that is accelerated by decreased consumption of network bandwidth, partial database objects 176-177 (e.g. database blocks 196-197) are flushed together in a same network transmission.

1.8 Rebuilding after Permanent Loss of Replica

Whenever a delta storage computer has replaced a database storage computer, distributed system 100 operates in a degraded mode that does not impact database server 120 and OLTP. During the degraded mode, coordination computer 160 may detect that the ongoing failure of a database replica is permanent and not temporary. In that case, coordination computer 160 may allocate a new database storage computer and new persistent storage to host and store a replacement replica. Allocation, configuration, and content population of the replacement replica and its database storage computer is referred to herein as rebuilding.

Recovery or rebuilding herein do not involve database server 120 and can occur without involvement of surviving storage computers and replicas as discussed later herein. For example, secondary replica database 110B may be replaced by rebuilding from an archived database snapshot that is older than delta 185, and delta 185 may be applied to the replica being rebuilt. Any data modifications that are in neither the database snapshot nor delta 185 can be retrieved from a surviving replica. In that way, delta storage computer 150B may accelerate rebuilding of a replacement of secondary replica database 110B. Acceleration techniques that are generally applicable to recovery and rebuilding are discussed later herein.

2.0 Example Transitions to and from Degraded Mode

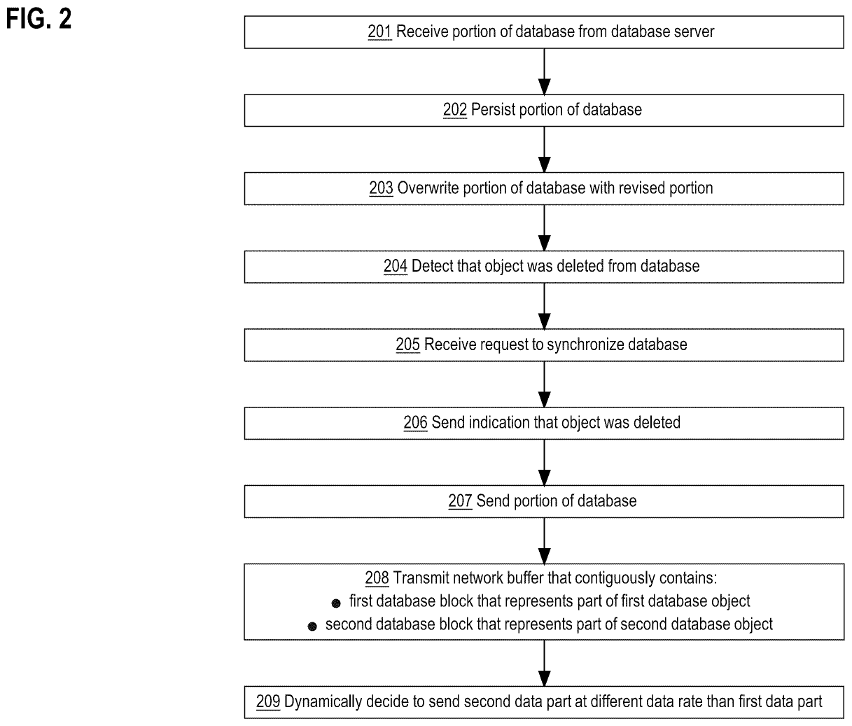

FIG. 2 is a flow diagram that depicts an example process that delta storage computer 150B may perform for recovery of replica secondary database 110B. An outage of either of components 110B or 130B causes the process of FIG. 2 to begin.

When coordinating computer 160 detects that replica secondary database 110B is unavailable, coordinating computer 160 performs remedial preparation including as discussed earlier herein: a) allocating and configuring delta storage computer 150B as a temporary replacement of database storage computer 130B and b) notifying database server 120 that delta storage computer 150B is a write-only temporary replacement of database storage computer 130B.

The process of FIG. 2 consists of a degraded phase that entails steps 201-204 followed by a recovery phase that entails steps 205-209. While replica secondary database 110B is unavailable, database server 120 may modify or generate portion 140A of replicated database 110. In step 201, storage computers 130A, 130C, and 150B receive portion 140A from database server 120 as discussed earlier herein, which more or less immediately causes delta storage computer 150B to store portion 140A into persistent storage 145 in step 202.

During ongoing ordinary OLTP operation, for example, database server 120 generates revised portion 140B such that portions 140A-B are different versions of a same data portion as discussed earlier herein. Storage computers 130A, 130C, and 150B receive revised portion 140B from database server 120, which causes delta storage computer 150B to react as follows.

In novel step 203, delta storage computer 150B performs: a) detect that revised portion 140B is a newer version, and portion 140A is an older version of a same data portion of replicated database 110 and b) responsively overwrite portion 140A with revised portion 140B in persistent storage 145.

In step 204, delta storage computer 150B detects that database object 171 or 172 is deleted from replicated database 110. For example, database server 120 may send object deletion 180 to storage computers 130A, 130C, and 150B. Delta storage computer 150B may receive, process, and persist object deletion 180 as discussed earlier herein. In persistent storage 145, novel step 204 deletes any database block(s) identified by object deletion 180.

As discussed earlier herein, coordinating computer 160 may monitor the availability of replica databases 110A-C. When components 110B and 130B are ready to begin recovery, coordinating computer 160 notifies storage computers 130B and 150B to begin recovery of replica secondary database 110B. In step 205, delta storage computer 150B receives database synchronization request 165 from coordinating computer 160. This causes delta storage computer 150B to send delta 185 to recovering database storage computer 130B, and this sending may entail some or all of steps 206-209 as follows.

In step 206, delta storage computer 150B includes object deletion 180 in the transmission of delta 185 as discussed earlier herein. In step 207, delta storage computer 150B includes revised portion 140B in the transmission of delta 185 as discussed earlier herein.

As discussed earlier herein, database blocks 196-197 may respectively represent partial database objects 176-177, and each of partial database objects 176-177 may be a part of a distinct respective database object. In a single network transmission for a single flushing of network buffer 191 that contiguously contains database blocks 196-197, step 208 transmits network buffer 191.

In a throttled recovery embodiment, the data transmission rate for delta 185 may fluctuate during recovery. Any of computers 130B, 150B, and 160 may be a monitoring computer that dynamically detects network saturation in which a communication network is fully utilized and lacks unused bandwidth. In that case, the monitoring computer notifies delta storage computer 150B to decrease the data rate of transmission of delta 185.

For example, database block 196 may be transmitted at an initial data rate and subsequently, in step 209, delta storage computer 150B may decide to transmit database block 197 at a lower or higher data rate. Thus, database blocks 196-197 may be transmitted at different data rates. Likewise, network buffers 191-192 may be transmitted at different data rates. If the monitoring computer does not detect network saturation during transmission of delta 185, the monitoring computer may notify delta storage computer 150B to increase the data rate of transmission of delta 185. In that way, any of computers 130B, 150B, and 160 may decide to opportunistically accelerate transmission of delta 185 without increasing latency of database server 120 and its surviving database storage computers. Thus, distributed system 100 can both accelerate transmission of delta 185 and maximize throughput of ongoing OLTP by database server 120, which minimizes OLTP latency during recovery.

### 3.0 Example Acceleration by Parallel Recovery of Multiple Replicas

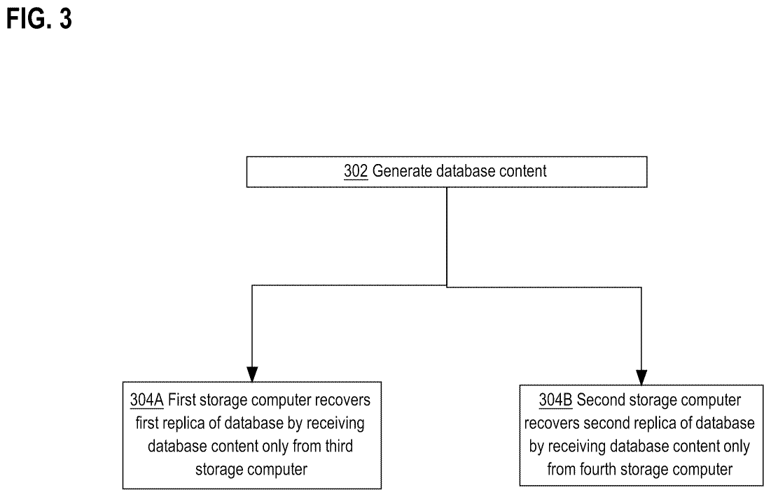

FIG. 3 is a flow diagram that depicts an example process that distributed system 100 may perform for concurrent recovery of replica databases 110A-110B. The process of FIG. 3 consists of a degraded phase that entails step 302 followed by a recovery phase that entails steps 304A-B that concurrently recover multiple replica databases 110A-B for accelerated full recovery to maximal replication. Database server 120 may perform ongoing OLTP during both degraded and recovery phases.

Database server 120 and surviving database replicas are not involved with recovery, no matter how many or few replicas are recovering or surviving. For example, surviving components 110C, 120, and 130C neither send nor receive recovery messages 165 and 185, and surviving components 110C, 120, and 130C are not involved with recovery steps 304A-B. In that way, the transactional throughput of distributed system 100 is not decreased by intensive (e.g. multiple replicas) recovery.

When the process of FIG. 3 begins, distributed system 100 is already degraded because replica databases 110A-B are unavailable. In step 302, database server 120 generates database content, such as database blocks 196-197 or partial database objects 176-177, and unavailable replica databases 110A-B are missing this recent database content.

Database server 120 performs step 302, and database storage computers 150A-B perform respective steps 304A-B. For accelerated recovery to maximal replication, steps 304A-B may be concurrent and both involve the same database content generated in step 302, referred to herein as the recent database content. This example involves two unavailable database replicas. Replica primary database 110A is a first unavailable database replica. Replica secondary database 110B is a second unavailable database replica.

This example involves four storage computers as follows. Database storage computer 130A is a first storage computer. Database storage computer 130B is a second storage computer. Delta storage computer 150A is a third storage computer. Delta storage computer 150B is a fourth storage computer. In step 304A, the first storage computer recovers the first database replica by receiving the recent database content only from the third storage computer as discussed earlier herein. In step 304B, the second storage computer recovers the second database replica by receiving the recent database content only from the fourth storage computer.

In that way, a recovery of one database replica entails only a single resynchronization between a single pair (i.e. sender and receiver) of storage computers. A separate pair of distinct storage computers is used to recover each unavailable database replica. If only one database replica is recovering, then only one pair of storage computers is needed. Each pair of storage computers performs a separate recovery, and multiple pairs independently operate and do not communicate with each other during recovery.

### 4.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

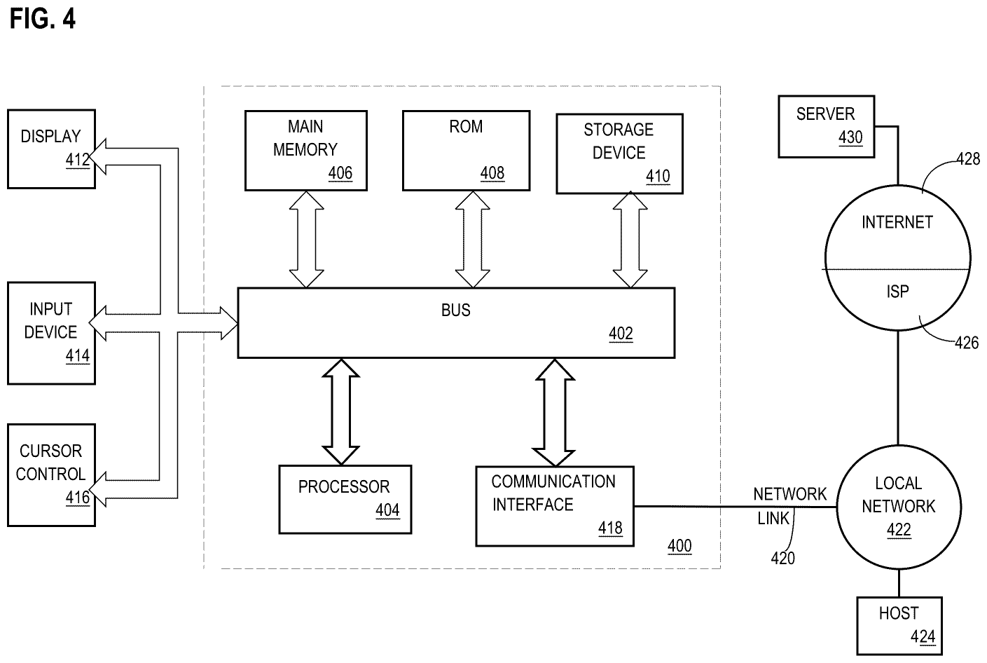

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

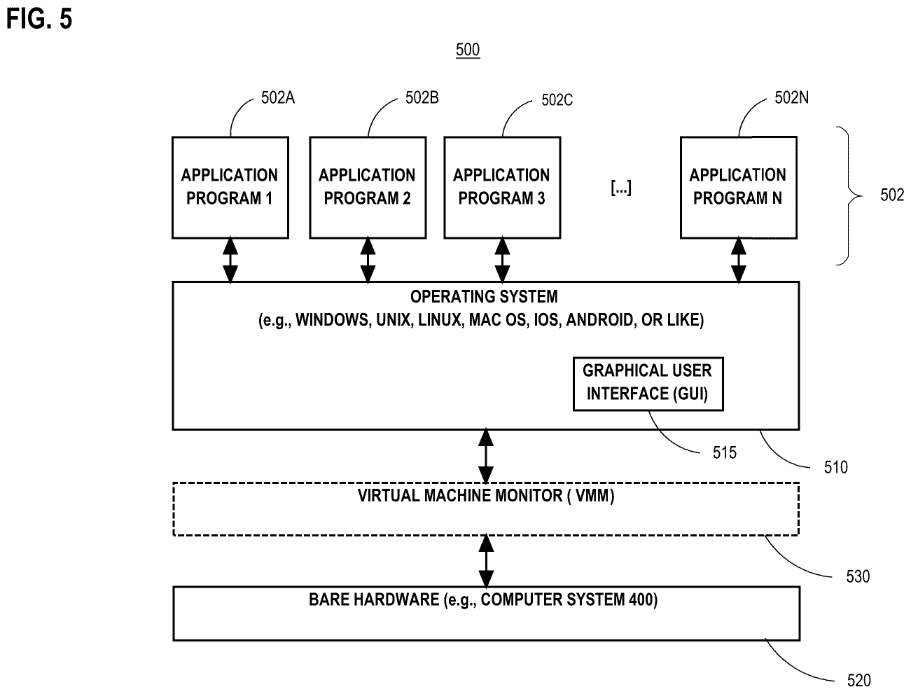

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
persisting a portion of a database;
receiving a request to synchronize the database; and
sending, in response to the request to synchronize the database, the portion of the database;
wherein the method is performed by a storage computer that is not allocated storage that stores the database.

2. The method of claim 1 further comprising overwriting said portion of the database with a revised portion of the database.

3. The method of claim 1 wherein the storage computer does not comprise a database server.

4. The method of claim 1 wherein:
said receiving the request comprises receiving from a coordinating computer;
said sending the portion of the database comprises sending to a second storage computer.

5. The method of claim 1 wherein:
the method further comprises receiving the portion of the database from a database server;
said receiving the request and said sending the portion do not involve the database server.

6. The method of claim 1 wherein:
said sending the portion of the database comprises transmitting a network buffer that contiguously contains a first database block that represents part of a first database object and a second database block that represents part of a second database object;
the first database object and the second database object are not parts of a same database table.

7. The method of claim 1 wherein:
the method further comprises detecting that an object was deleted from the database;
the portion of the database does not contain the object;
the method further comprises sending, in response to the request to synchronize the database, an indication that the object was deleted.

8. The method of claim 1 wherein:
the method further comprises:
receiving the portion of the database including a first object and a second object, and
detecting that the second object was deleted from the database;
said sending the portion of the database does not comprise sending the second object.

9. The method of claim 8 wherein the second object is selected from a group consisting of:
a file, a volume, a database snapshot, a database block, and a tablespace.

10. The method of claim 1 wherein said sending the portion of the database comprises sending to a replica of the database while the replica is being recovered.

11. The method of claim 10 wherein the storage computer is configured not to read the portion of the database from persistent storage until said receiving the request to synchronize.

12. The method of claim 1 wherein:
said sending the portion of the database comprises sending a first data part and a second data part;
the method further comprises after sending the first data part, dynamically deciding to send the second data part at a different data rate than the first data part.

13. A method comprising:
concurrently performing:
first recovering, by a first storage computer, a first replica of a database by receiving a database content only from a third storage computer, and
second recovering, by a second storage computer, a second replica of the database by receiving the database content only from a fourth storage computer;
wherein the third storage computer and the fourth storage computer are not allocated storage that stores the database.

14. The method of claim 13 further comprising generating the database content while the first replica of the database and the second replica of the database are unavailable.

15. The method of claim 13 wherein said first recovering and said second recovering do not entail content interpretation.

16. A method comprising:
detecting, by a first computer, that a replica of a database that contains a plurality of database blocks is unavailable;
persisting, by a second computer in response to said detecting, a subset of the plurality of database blocks that were modified after the replica of the database became unavailable;
wherein the second computer is not allocated storage that stores the database.

17. One or more non-transitory computer-readable media storing instructions that, when executed by a first computer and a second computer, cause:
detecting, by the first computer, that a replica of a database that contains a plurality of database blocks is unavailable;
persisting, by the second computer in response to said detecting, a subset of the plurality of database blocks that were modified after the replica of the database became unavailable;
wherein the second computer is not allocated storage that stores the database.

18. One or more non-transitory computer-readable media storing instructions that, when executed by a storage computer, cause:
persisting a portion of a database;
receiving a request to synchronize the database; and
sending, in response to the request to synchronize the database, the portion of the database;
wherein the storage computer is not allocated storage that stores the database.

19. The one or more non-transitory computer-readable media of claim 18 wherein the instructions further cause overwriting said portion of the database with a revised portion of the database.

20. The one or more non-transitory computer-readable media of claim 18 wherein:
the instructions further cause receiving the portion of the database from a database server;
said receiving the request and said sending the portion do not involve the database server.

21. The one or more non-transitory computer-readable media of claim 18 wherein:
the instructions further cause:
receiving the portion of the database including a first object and a second object, and
detecting that the second object was deleted from the database;
said sending the portion of the database does not comprise sending the second object.

22. One or more non-transitory computer-readable media storing instructions that, when executed by a first storage computer and a second storage computer, cause:
concurrently performing:
first recovering, by the first storage computer, a first replica of a database by receiving a database content only from a third storage computer, and
second recovering, by the second storage computer, a second replica of the database by receiving the database content only from a fourth storage computer;
wherein the third storage computer and the fourth storage computer are not allocated storage that stores the database.

23. The one or more non-transitory computer-readable media of claim 22 wherein the instructions further cause generating the database content while the first replica of the database and the second replica of the database are unavailable.

24. The one or more non-transitory computer-readable media of claim 22 wherein said first recovering and said second recovering do not entail content interpretation.
